(19) United States
(12) Patent Application Publication
(10) Pub. No.: US 2010/0325090 A1
(43) Pub. Date: Dec. 23, 2010

(54) ELECTRONIC DEVICE FOR FACILITATING FILE COPYING

(75) Inventor: XU-XING YAN, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/551,432

(22) Filed: Aug. 31, 2009

(30) Foreign Application Priority Data
Jun. 22, 2009 (CN) 200910303490.1

(51) Int. Cl. G06F 17/30; G06F 3/041

(52) U.S. Cl. 707/640; 345/173; 707/674; 707/704

(57) ABSTRACT

An electronic device includes two directories, one of which stores an image file. The electronic device also includes a window generating unit and a multi-touch screen. The window generating unit generates a window on the multi-touch screen. The window display the image file as an image and two representations for accessing the two directories correspondingly. The electronic device also includes a detecting unit and a copying unit. The detecting unit detects an operation by a user on the multi-touch screen and recognizes if the operation is a copy command based upon a database thereof and the locations of the image and the representations. If yes, the copying unit copies the image file from one of the directories to the other.

### BACKGROUND

1. Technical Field

The present disclosure relates to electronic devices and, particularly, to an electronic device which facilitates copying a currently displayed image from one directory to another.

2. Description of Related Art

To copy a currently browsed image from one directory to another in most conventional electronic devices, complicated menu operations are required. This is inconvenient and time-consuming.

Therefore, it is desirable to provide an electronic device to overcome the above-mentioned problems.

### BRIEF DESCRIPTION OF THE DRAWINGS

FIG. 1 is a functional block diagram of an electronic device, according to an exemplary embodiment of the present disclosure.

FIG. 2 is a first view of a multi-touch screen of the electronic device of FIG. 1.

FIG. 3 is a second view of a multi-touch screen of the electronic device of FIG. 1.

FIG. 4 is a third view of a multi-touch screen of the electronic device of FIG. 1.

### DETAILED DESCRIPTION

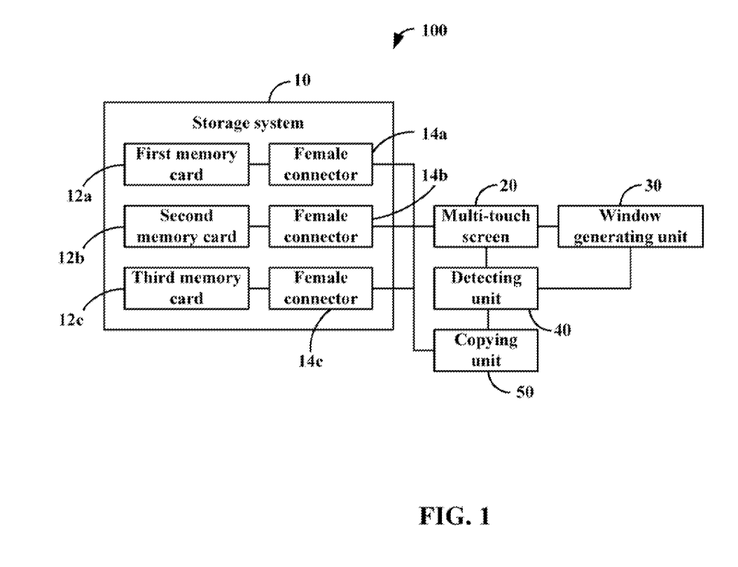

Referring to FIG. 1, an electronic device 100, according to an exemplary embodiment, can be a digital camera. The electronic device 100 includes a storage system 10, a multi-touch screen 20, a window generating unit 30, a detecting unit 40, and a copying unit 50.

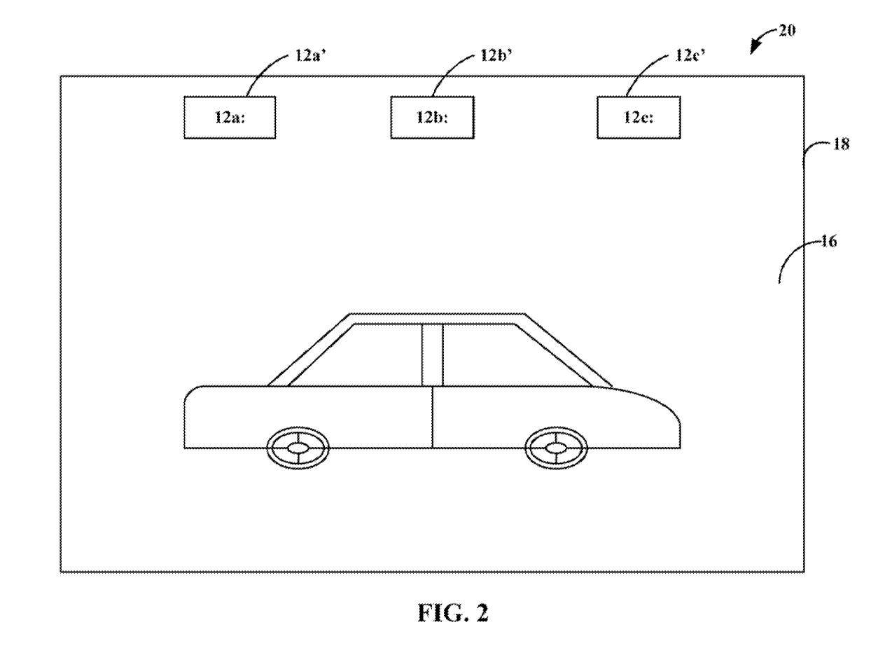

The storage system 10 includes a first memory card 12a, a second memory card 12b, and a third memory card 12c. Each of the first memory card 12a, the second memory card 12b, and the third memory card 12c can be a flash memory card, a security digital card, or a mini security digital card, and includes a male connector (not shown), e.g., a universal bus drive (USB) plug. The electronic device 100 includes three female connectors 14a, 14b, 14c, e.g., USB sockets. The first memory card 12a, the second memory card 12b, and the third memory card 12c are connected to the electronic device 100 by plugging the male connectors into the female connectors 14a, 14b, 14c, correspondingly. As such, each one of the first memory card 12a, the second memory card 12b, and the third memory card 12c works as a directory of the storage system 10. The first memory card 12a stores an image (file) 16 (see FIG. 2). That is, the image (file) 16 is located in the directory 12a.

It should be understood that the storage system 10 is not limited to this embodiment. In other embodiments, the storage system 10 may include only one memory card which is partitioned into several directories, and the image (file) 16 is located in one of the directories.

Referring to FIG. 2, the multi-touch screen 20, such as a liquid crystal display (LCD) based touch screen, is configured for providing a user interface. For example, the multi-touch screen 20 can display an information window 18, while receiving operations by the user.

The window generating unit 30 is configured for reading information, e.g., directory information and file allocation information, from the storage system 10 and generating the information window 18 correspondingly. The information window 18 displays the image 16 and three representations 12a′, 12b′, 12c′ of the first memory card 12a, the second memory card 12b, and the third memory card 12c correspondingly. Each of the representations 12a′, 12b′, 12c′ is for accessing a corresponding directory of the storage system 10. After the window 18 is generated, the window generating unit 30 records locations of the image 16, and the three representations 12a′, 12b′, 12c′.

It should be understood that the information window 18 is not limited to this embodiment, and can be set (e.g., edited) depending on requirements of the users.

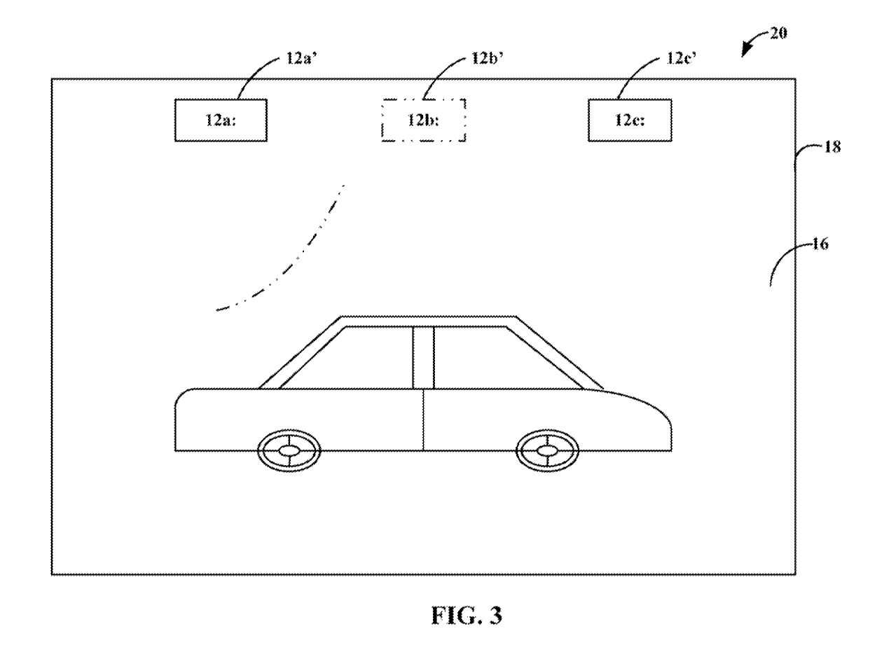

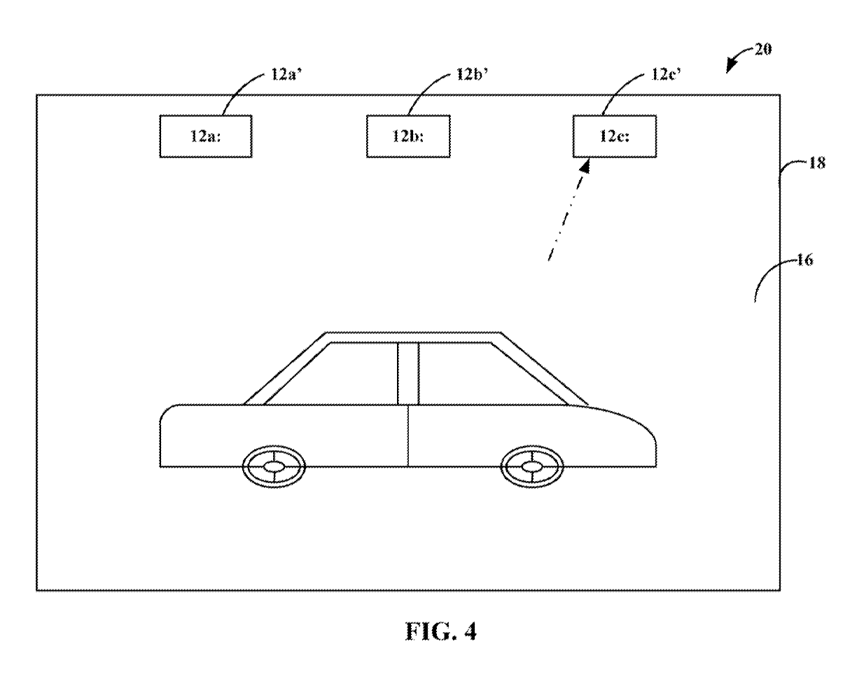

The detecting unit 40 is configured for detecting an operation by the user on the multi-touch screen 20 and recognizing if the operation is a copy command, according to the locations of the image 16 and the three representations 12a′, 12b′ 12c′. In detail, the detecting unit 40 includes a database (not shown). An operation command such as a copy command is defined in the database. The detecting unit 40 judges if an operation is a copy command based upon the database. For example, referring to FIG. 3, if the detected operation of sliding a stylus or a finger across the image 16 and then tapping the representation 12b′ (illustrated by the dotted curved line and the dotted the representation 12b′ in FIG. 3) is defined in the database as a copy command, the image (file) 16 is copied to the directory: 12b (i.e., the second memory card 12). Also referring to FIG. 4, if the detected operation of dragging the image 16 into the representation 12c′ (represented by the dotted arrow in FIG. 4) is defined as a copy command, the image (file) 16 is copied to the directory 12c (i.e., the third memory card 12c).

The copying unit 50 is configured for executing the copy command. Namely, the copying unit 50 is for copying files from the directories 12a, 12b, and 12c. For example, the copy unit 50 can copy the image (file) 16 from the directory 12a to the directories 12b, 12c.

While various exemplary and preferred embodiments have been described, it is to be understood that the disclosure is not limited thereto. To the contrary, various modifications and similar arrangements (as would be apparent to those skilled in the art) are intended to also be covered. Therefore, the scope of the appended claims should be accorded the broadest interpretation so as to encompass all such modifications and similar arrangements.

What is claimed is:

1. An electronic device comprising:
a storage system comprising a first directory and a second directory, the first directory comprising an image file;
a multi-touch screen configured for displaying an information window which displays the image file, as an image, and two representations for accessing the first directory and the second directory correspondingly, the multi-touch screen being configured for receiving an operation by a user;
a window generating unit configured for reading information of the storage system and generating the information window correspondingly, the window generating unit also configured for recording locations of the image and the representations;
a detecting unit comprising a database which defines if an operation is a copy command, the detecting unit being configured for detecting the operation by the user and recognizing if the operation is a copy command based upon the database and according to the locations of the image and the representations; and
a copying unit configured for executing the copy command.

2. The electronic device of claim 1, wherein the storage system comprising a first memory card and a second memory card, the first directory is the first memory card, and the second directory is the second memory card.

3. The electronic device of claim 1, wherein each of the first memory card and the second memory card is selected from the group consisting of a flash memory card, a security digital card, and a mini security digital card.

4. The electronic device of claim 1, wherein each of the first memory card and the second memory card comprises a first connector, the electronic device further comprising two second connectors, the first memory card and the second memory card being connected to the electronic device by connecting the first connectors with the second connectors.

5. The electronic device of claim 1, wherein the storage system comprises a memory card, the memory card being partitioned into the first directory and the second directory.

6. The electronic device of claim 1, wherein the multi-touch screen is liquid crystal display based.

7. The electronic device of claim 1, wherein the database defines that an operation involving sliding across the image and then tapping on one of the two representations defining the second directory is a copy command of copying the image file from the first directory to the second directory.

8. The electronic device of claim 1, wherein the database defines that an operation involving dragging the image to one of the two representations defining the second directory is a copy command of copying the image file from the first directory to the second directory.
